(19) United States
(12) Patent Application Publication
(10) Pub. No.: US 2025/0141055 A1
(43) Pub. Date: May 1, 2025

(54) BATTERY MODULE AND BATTERY PACK

(71) Applicant: EVE ENERGY STORAGE CO., LTD, WUHAN (CN)

(72) Inventors: MINGLI WU, WUHAN (CN); YONG LIAO, WUHAN (CN); XIN ZHAO, WUHAN (CN)

(21) Appl. No.: 19/008,651

(22) Filed: Jan. 3, 2025

Related U.S. Application Data
(63) Continuation-in-part of application No. PCT/CN2024/106981, filed on Jul. 23, 2024.

(30) Foreign Application Priority Data
Aug. 4, 2023 (CN) 202322098295.8

(51) Int. Cl. H01M 50/507; H01M 50/227; H01M 50/233; H01M 50/262; H01M 50/298; H01M 50/517

(52) U.S. Cl. CPC H01M 50/507; H01M 50/227; H01M 50/233; H01M 50/262; H01M 50/298; H01M 50/517

(57) ABSTRACT

A battery module and a battery pack are provided. The battery module includes a plurality of cells and a busbar assembly. The busbar assembly includes a first plastic bracket and a plurality of aluminum busbars each for connecting two adjacent cells. At least one of the plurality of the aluminum busbars are arranged on the first plastic bracket. The first plastic bracket is provided with heat rivet posts corresponding one-to-one with the aluminum busbars arranged on the first plastic bracket. The aluminum busbar is provided with a fixing hole matching the heat rivet post. The heat rivet post is configured to insert into the fixing hole, where at least a portion of a circumferential sidewall of the heat rivet post cooperates with at least a portion of an inner wall of the fixing hole, to fix the aluminum busbar at a circumferential position of the heat rivet post.

### CROSS-REFERENCE TO RELATED APPLICATION

The present disclosure is a continuation in part application of International Application No. PCT/CN2024/106981, filed on Jul. 23, 2024, which claims priority to Chinese Patent Application No. 202322098295.8, filed on Aug. 4, 2023, the disclosure of which are incorporated herein by reference in their entireties.

### TECHNICAL FIELD

The present disclosure relates to the technology field of batteries, and in particular, to a battery module and a battery pack.

### BACKGROUND

Battery modules usually include a plurality of cells and a busbar assembly for connecting the plurality of cells. Specifically, the busbar assembly consists of aluminum busbars for connecting the cells in series or in parallel, and a plastic bracket for carrying the aluminum busbars. When in use, the plastic bracket is arranged between the cells and the aluminum busbars, and positive electrodes or negative electrodes of the cells pass through the plastic bracket and are welded to the aluminum busbars.

In related technologies, when assembling the aluminum busbar to the plastic bracket and welding the aluminum busbar to its corresponding cells, in order to prevent the aluminum busbar from being misaligned during a welding process, it is necessary to temporarily fix the aluminum busbar by using tape or double-sided tape. After the welding is completed, the tape or double-sided tape used for temporary fixing needs to be removed.

The above fixing manner has low precision, and the temporary fixing steps are cumbersome. In addition, during the process of removing the tape or double-sided tape after the welding is completed, there is a risk of damaging the connection structures between the aluminum busbar and the cells and causing a false weld.

### SUMMARY

In a first aspect, the present disclosure provides a battery module, including a plurality of cells and a busbar assembly. The busbar assembly includes a first plastic bracket and a plurality of aluminum busbars each for connecting two adjacent cells. At least one of the plurality of the aluminum busbars are arranged on the first plastic bracket. The first plastic bracket is provided with a plurality of heat rivet posts corresponding one-to-one with the aluminum busbars arranged on the first plastic bracket. The aluminum busbar is provided with a fixing hole matching the heat rivet post. The heat rivet post is configured to insert into the fixing hole, where at least a portion of a circumferential sidewall of the heat rivet post cooperates at least a portion of an inner wall of the fixing hole, to fix the aluminum busbar at a circumferential position of the heat rivet post.

In a second aspect, the present disclosure provides a battery pack, including the foregoing battery module.

### BRIEF DESCRIPTION OF THE DRAWINGS

FIG. 1 is a three-dimensional structural schematic diagram of a first plastic bracket after being assembled with aluminum busbars according to some embodiments.

FIG. 2 is a first three-dimensional structural schematic diagram of a battery module according to some embodiments.

FIG. 3 is an exploded structural schematic diagram of a battery module according to some embodiments.

FIG. 4 is a three-dimensional structural schematic diagram of a battery module after removing one battery row according to some embodiments.

FIG. 5 is a second three-dimensional structural schematic diagram of a battery module according to some embodiments.

FIG. 6 is a schematic diagram of a battery pack according to some embodiments.

Reference numerals in the drawings: 1000, battery pack; 1, battery module; 10, busbar assembly; 10a, first plastic bracket; 10b, second plastic bracket; 101, sinking groove; 102, connection through hole; 103, heat rivet post; 104, positive busbar; 105, first fixing post; 1051, first locking through hole; 106, second fixing post; 1061, second locking through hole; 1056, reinforcing rib; 107, negative busbar; 110, aluminum busbar; 111, fixing hole; 120, collection line; 121, crimped nickel sheet; 122, connector; 20, cell; 210, positive pole; 220, negative pole; R1, first battery row; R2, second battery row.

### DETAILED DESCRIPTION

In the description of the present disclosure, it should be noted that orientations or positional relationships indicated by the terms “upper”, “lower”, “front”, “rear”, “left”, “right”, “vertical”, “horizontal”, “top”, “bottom”, “inside” and “outside”, etc., are based on the orientations or positional relationships shown in the accompanying drawings, and are only for the convenience of describing the present disclosure and simplifying the description, rather than indicating or implying that devices or components referred to must have a specific orientation, be constructed and operated in a specific orientation, and therefore should not be understood as a limitation on the present disclosure.

Unless otherwise defined, all technical and scientific terms used herein have the same meaning as commonly understood by one of ordinary skill in the art to which this disclosure belongs. The terms used in the description of the present disclosure are only for the purpose of describing specific embodiments and are not intended to limit the present disclosure.

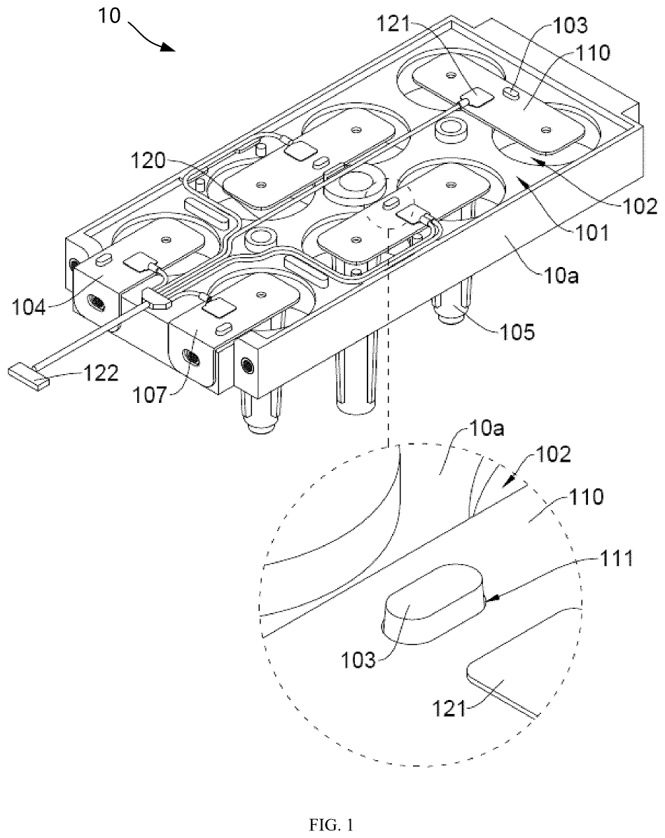

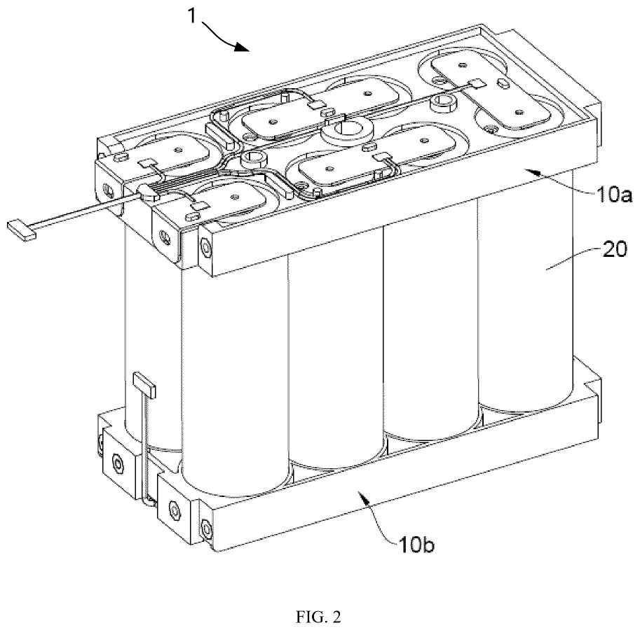

Please refer to FIGS. 1 to 5, a battery module 1 includes a plurality of cells 20 and a busbar assembly 10. The busbar assembly 10 includes a first plastic bracket 10a and a plurality of aluminum busbars 110 each for connecting two adjacent cells 20 in series or in parallel. The aluminum busbars 110 are arranged on a top surface of the first plastic bracket 10a. The top surface of the first plastic bracket 10a is provided with a plurality of heat rivet posts 103 corresponding one-to-one with the aluminum busbars 110 arranged on the first plastic bracket (10a). The aluminum busbar 110 is provided with a fixing hole 111 matching the heat rivet post 103. The heat rivet post 103 is inserted into the fixing hole 111, and at least a portion of a circumferential sidewall of the heat rivet post 103 cooperates with at least a portion of an inner wall of the fixing hole 111, to fix the aluminum busbar 110 at a circumferential position of the heat rivet post 103.

In this embodiment, the first plastic bracket 10a is further provided with a plurality of connection through holes 102 formed on the first plastic bracket 10a. The plurality of connection through holes 102 correspond one-to-one with the plurality of cells 20. A positive pole 210 and a negative pole 220 of the cell 20 are connected to the aluminum busbar 110 through their corresponding connection through holes 102.

When in use, the aluminum busbar 110 is placed on the top surface of the first plastic bracket 10a, and its corresponding heat rivet post 103 passes through the fixing hole 111 on the aluminum busbar 110. By an interaction between the heat rivet post 103 and the fixing hole 111, the aluminum busbar 110 and the heat rivet post 103 are relatively fixed in a circumferential direction of the heat rivet post 103, thereby realizing a pre-fixation of the aluminum busbar 110, facilitating the welding and fixation of the aluminum busbar 110 and the cells 20, and being beneficial to improving the pre-fixation efficiency and accuracy of the aluminum busbar 110.

In some embodiments, the heat rivet post 103 extends in a direction away from the top surface of the first plastic bracket 10a.

In some embodiments, an axial cross-section of the heat rivet post 103 is in any one of a polygonal shape, a semicircular shape, a waist shape, and an elliptical shape. It can be understood that when the axial cross-section of the heat rivet post 103 is in a polygonal shape, a contour of the fixing hole 111 is in a corresponding polygonal shape, such as a triangle, a hexagon, etc. When the axial cross-section of the heat rivet post 103 is in a semicircular shape, the contour of the fixing hole 111 is in a corresponding semicircular shape. The same applies to a waist shape and an elliptical shape. After the circumferential sidewall of the heat rivet post 103 having the above-mentioned shape cooperate with the inner wall of the fixing hole 111, they can limit each other in the circumferential direction of the heat rivet post 103, so as to achieve the pre-fixation of the aluminum busbar 110.

It should be noted that the axial cross-section of the heat rivet post 103 may also be in other shapes, and is not limited to the shapes listed above, as long as the heat rivet post 103 and the fixing hole 111 can be mutually limited in the circumferential direction of the heat rivet post 103.

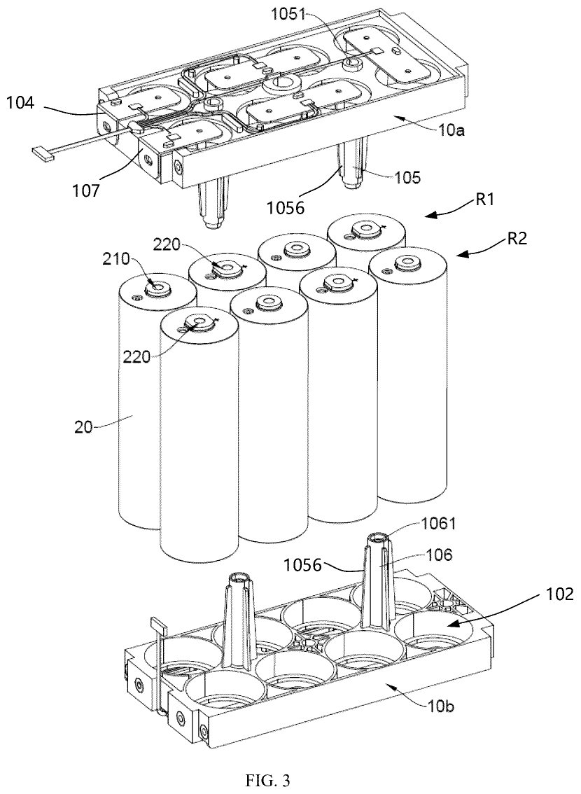

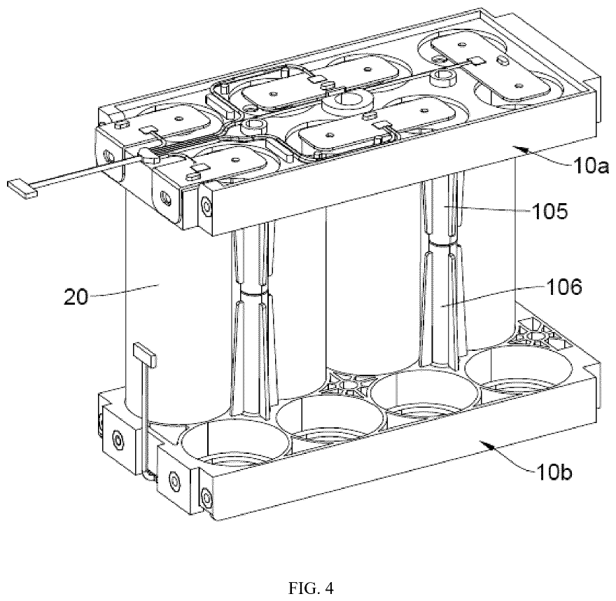

As shown in FIGS. 3 and 4, in some embodiments, the busbar assembly 10 further includes a second plastic bracket 10b. The second plastic bracket 10b is arranged opposite to the first plastic bracket 10a, and the cells 20 are arranged between the first plastic bracket 10a and the second plastic bracket 10b. One side of the first plastic bracket 10a facing the second plastic bracket 10b is provided with first fixing posts 105, and one side of the second plastic bracket 10b facing the first plastic bracket 10a is provided with second fixing posts 106 corresponding one-to-one with the first fixing posts 105. The first fixing post 105 and the second fixing post 106 are coaxially connected, and an axis of the first fixing post 105 and the second fixing post 106 is located in a gap among the cells 20. In some embodiments, the first fixing post 105 and the second fixing post 106 are connected to each other to achieve an connection between the first plastic bracket 10a and the second plastic bracket 10b.

In some embodiments, in order to improve the firmness of the first plastic bracket 10a and the second plastic bracket 10b after assembly, the first fixing post 105a is provided with a first locking through hole 1051, and the second fixing post 106 is provided with a second locking through hole 1061. When the first fixing post 105 and the second fixing post 106 are coaxially connected, the first locking through hole 1051 and the second locking through hole 1061 are coaxial. The battery module 1 further includes fixing rods (not shown in the figure). One end of the fixing rod close to the first plastic bracket (10a) is provided with a first fixing block (not shown in the figure), and the other end of the fixing rod close to the second plastic bracket (10b) is provided with a second fixing block (not shown in the figure). The first fixing block is configured to abut against one end of the first fixing post 105 away from the second fixing post 106, and the second fixing block is configured to abut against one end of the second fixing post 106 away from the first fixing post 105. When in use, the fixing rod is inserted into the first locking through hole 1051 and the second locking through hole 1061, the first fixing block is pressed against an outer end of the first locking through hole 1051 of the first fixing post 105, and the second fixing block is pressed against an outer end of the second locking through hole 1061. In some embodiments, the first fixing block and the fixing rod are integrally formed, and the second fixing block is threadedly connected to the fixing rod. The first plastic bracket 10a and the second plastic bracket 10b are firmly fixed by coordinating the fixing rod with the second fixing block, thereby effectively improving the structural stability of the battery module 1. In some embodiments, the first fixing block and the second fixing block are both threadedly connected to the fixing rod.

In some embodiments, a circumferential sidewall of each of the first fixing post 105 and the second fixing post 106 is provided with reinforcing ribs 1056, thereby effectively improving the structural strength of the first fixing post 105 and the second fixing post 106.

As shown in FIG. 3, the cell 20 is a cylindrical cell, the positive pole 210 of the cell 20 is located at one axial end of the cell 20, and the negative pole 220 of the cell 20 is located at the other axial end of the cell 20. In this embodiment, eight cells 20 are taken as an example for description. Specifically, four of the eight cells 20 are arranged in a length direction of the battery module 1, which is defined as a first battery row R1; the other four of the eight cells 20 are arranged in a length direction of the battery module 1, which is defined as a second battery row R2. In a length direction of the first battery row R1, the positive pole 210 of the first cell 20 is arranged toward the first plastic bracket 10a, and the negative pole 220 of the first cell 20 is arranged toward the second plastic bracket 10b; the negative pole 220 of the second cell 20 is arranged toward the first plastic bracket 10a, and the positive pole 210 of the second cell 20 is arranged toward the second plastic bracket 10b. In some embodiments, in the battery row R1 or R2, the directions of the poles of the cells 20 arranged at odd positions are consistent, the directions of the poles of the cells 20 arranged at even positions are consistent, and the directions of the poles of the cells 20 arranged at odd positions are opposite to the directions of the poles of the cells 20 arranged at even positions.

The aluminum busbar 110 connects two adjacent cells 20 in series in the length direction of the battery row R1 or R2. Specifically, as shown in FIG. 3, in the first battery row R1, the positive pole 210 of the first cell 20 is connected to a positive busbar 104, which is served as a positive terminal of the battery module 1; the negative pole 220 of the second cell 20 and the positive pole 210 of the third cell 20 are connected in series by the aluminum busbar 110; the negative pole 220 of the fourth cell 20 and the positive pole 210 of the fourth cell 20 of the second battery row R2 are connected in series by the aluminum busbar 110, and so on. The negative pole 220 of the first cell 20 of the second battery row R2 is connected to a negative busbar 107, which is served as a negative terminal of the battery module 1.

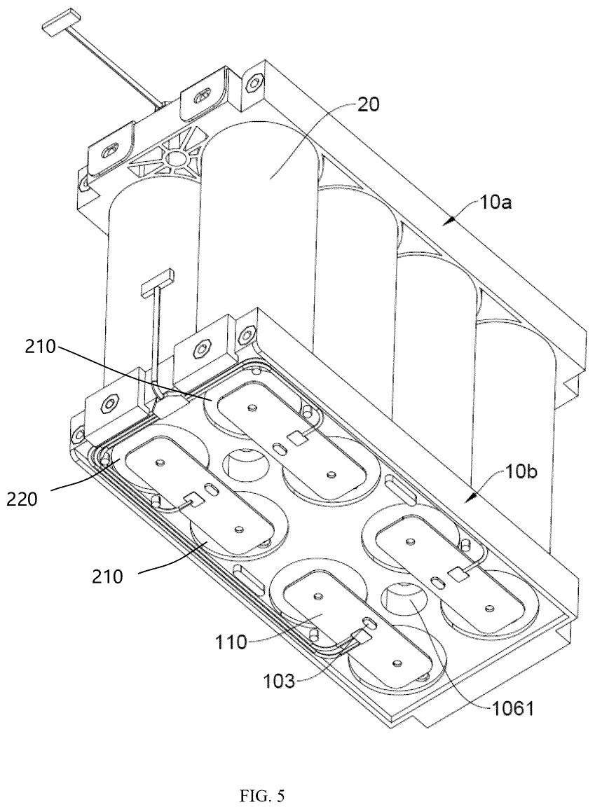

Correspondingly, as shown in FIG. 5, one side of the second plastic bracket 10b facing away from the first plastic bracket 10a is provided with heat rivet posts 103 and aluminum busbars 110 that are the same as those provided on the top surface of the first plastic bracket 10a, which cooperates with the aluminum busbar 110 provided on the first plastic bracket 10a to connect two adjacent cells 20 along the length direction of the battery row R1 or R2 in series. In some embodiments, as shown in FIGS. 3 and 5, the second plastic bracket 10b is further provided with a plurality of connection through holes 102 corresponding one-to-one with the plurality of cells 20. A positive pole 210 and a negative pole 220 of the cell 20 are connected to the aluminum busbar 110 through their corresponding connection through holes 102. Specifically, in the first battery row R1, the negative pole 220 of the first cell 20 and the positive pole 210 of the second cell 20 in the length direction of the first battery row R1 are connected in series by the aluminum busbar 110, and the negative pole 220 of the third cell 20 and the positive pole 210 of the fourth cell 20 are connected in series by the aluminum busbar 110; the four cells 20 of the second battery row R2 are connected in series in a similar manner as the four cells 20 of the first battery row R1, specifically as shown in FIG. 5.

In this embodiment, as show in FIG. 1, the battery module 1 further includes collection lines 120. An input end of each collection line 120 is provided with a crimped nickel sheet 121. The crimped nickel sheet 121 is connected to at least one of the aluminum busbars 110. An output end of the collection line 120 is connected to a connector 122. The collection line 120 transmits temperature and pressure signals collected by the crimped nickel sheet 121 to the connector 122, and the connector 122 is connected to a BMS to manage the battery module 1 according to the temperature and pressure signals.

In some embodiments, the first plastic bracket 10a and the second plastic bracket 10b have the same appearance. When in use, the two are arranged in a mirrored manner.

In this embodiment, the top surface of the first plastic bracket 10a is provided with a sinking groove 101. The heat rivet posts 103 are arranged at a bottom of the sinking groove 101, and the aluminum busbars 110 provided on the first plastic bracket 10a are arranged in the sinking groove 101. The sinking groove 101 here can accommodate the aluminum busbars 110 and the collection lines 120, which is helpful to reduce the overall height of the busbar assembly 10.

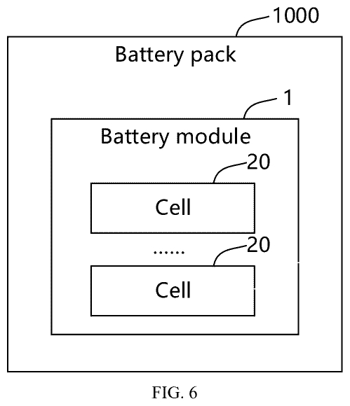

As shown in FIG. 6, embodiments of the present disclosure further provides a battery pack 1000, which includes the above-mentioned battery module 1. The busbar assembly 10 of the battery pack 1000 is easy to assemble and has high efficiency.

What is claimed is:

1. A battery module (1), comprising:
a plurality of cells (20); and
a busbar assembly (10) comprising a first plastic bracket (10a) and a plurality of aluminum busbars (110) each for connecting two adjacent cells (20), wherein at least one of the plurality of the aluminum busbars (110) are arranged on the first plastic bracket (10a);
wherein the first plastic bracket (10a) is provided with a plurality of heat rivet posts (103) corresponding one-to-one with the aluminum busbars (110) arranged on the first plastic bracket (10a); the aluminum busbar (110) is provided with a fixing hole (111) matching the heat rivet post (103);
the heat rivet post (103) is configured to insert into the fixing hole (111), wherein at least a portion of a circumferential sidewall of the heat rivet post (103) cooperates with at least a portion of an inner wall of the fixing hole (111), to fix the aluminum busbar (110) at a circumferential position of the heat rivet post (103).

2. The battery module (1) according to claim 1, wherein the heat rivet post (103) extends in a direction away from the first plastic bracket (10a).

3. The battery module (1) according to claim 1, wherein an axial cross-section of the heat rivet post (103) is in any one of a polygonal shape, a semicircular shape, a waist shape, and an elliptical shape.

4. The battery module (1) according to claim 1, wherein the busbar assembly (10) further comprises a second plastic bracket (10b), wherein the second plastic bracket (10b) is arranged opposite to the first plastic bracket (10a), and the cells (20) are arranged between the first plastic bracket (10a) and the second plastic bracket (10b);
one side of the first plastic bracket (10a) facing the second plastic bracket (10b) is provided with first fixing posts (105), and one side of the second plastic bracket (10b) facing the first plastic bracket (10a) is provided with second fixing posts (106) corresponding one-to-one with the first fixing posts (105);
wherein the first fixing post (105) and the second fixing post (106) are coaxially connected, and an axis of the first fixing post (105) and the second fixing post (106) is located in a gap among the cells (20).

5. The battery module (1) according to claim 4, wherein the first fixing post (105) is provided with a first locking through hole (1051), and the second fixing post (106) is provided with a second locking through hole (1061);
when the first fixing post (105) and the second fixing post (106) are coaxially connected, the first locking through hole (1051) and the second locking through hole (1061) are coaxial;
the battery module (1) further comprises a fixing rod that passes through the first locking through hole (1051) and the second locking through hole (1061); wherein one end of the fixing rod close to the first plastic bracket (10a) is provided with a first fixing block, the other end of the fixing rod close to the second plastic bracket (10b) is provided with a second fixing block; the first fixing block is configured to abut against one end of the first fixing post (105) away from the second fixing post (106), and the second fixing block is configured to abut against one end of the second fixing post (106) away from the first fixing post (105).

6. The battery module (1) according to claim 4, wherein a circumferential sidewall of each of the first fixing post (105) and the second fixing post (106) is provided with reinforcing ribs (1056).

7. The battery module (1) according to claim 5, wherein at least one of the first fixing block and the second fixing block is threadedly connected to the fixing rod.

8. The battery module (1) according to claim 1, wherein a top surface of the first plastic bracket (10a) is provided with a sinking groove (101); wherein the heat rivet post (103) is arranged at a bottom of the sinking groove (101), and the aluminum busbars (110) provided on the first plastic bracket (10a) are arranged in the sinking groove (101).

9. The battery module (1) according to claim 1, wherein the battery module (1) further comprises collection lines (120), wherein an input end of the collection line (120) is provided with a crimped nickel sheet (121), wherein the crimped nickel sheet (121) is connected to at least one of the aluminum busbars (110);
an output end of the collection line (120) is connected to a connector (122).

10. The battery module (1) according to claim 8, wherein the first plastic bracket (10a) is further provided with a plurality of connection through holes (102) corresponding one-to-one with the plurality of cells (20); a positive pole (210) and a negative pole (220) of the cell (20) are connected to the aluminum busbar (110) through corresponding connection through holes (102).

11. The battery module (1) according to claim 4, wherein at least one of the plurality of the aluminum busbars (110) are arranged on the second plastic bracket (10b);
wherein the aluminum busbars (110) arranged on the second plastic bracket (10b) are configured to cooperate with the aluminum busbar (110) arranged on the first plastic bracket (10a) to connect the cells (20) in series.

12. The battery module (1) according to claim 11, wherein the second plastic bracket (10b) is provided with a plurality of heat rivet posts (103) corresponding one-to-one with the aluminum busbars (110) arranged on the second plastic bracket (10b) and for fixing the aluminum busbars (110) on the second plastic bracket (10b).

13. The battery module (1) according to claim 11, wherein the aluminum busbar (110) connects a positive pole (210) of one of the two adjacent cells (20) and a negative pole (220) of the other one of the two adjacent cells (20), thereby connecting the two adjacent cells in series.

14. The battery module (1) according to claim 11, wherein the aluminum busbar (110) are arranged on a top surface of the first plastic bracket (10a) and one side of the second plastic bracket (10b) facing away from the first plastic bracket (10a), respectively;
each of the first plastic bracket (10a) and the second plastic bracket (10b) is further provided with a plurality of connection through holes (102) corresponding one-to-one with the plurality of cells (20); a positive pole (210) and a negative pole (220) of the cell (20) are connected to the aluminum busbar (110) through corresponding connection through holes (102).

15. A battery pack (1000), comprising the battery module (1), the battery module (1) comprising:
a plurality of cells (20); and
a busbar assembly (10) comprising a first plastic bracket (10a) and a plurality of aluminum busbars (110) each for connecting two adjacent cells (20), wherein at least one of the plurality of the aluminum busbars (110) are arranged on the first plastic bracket (10a);
wherein the first plastic bracket (10a) is provided with a plurality of heat rivet posts (103) corresponding one-to-one with the aluminum busbars (110) arranged on the first plastic bracket (10a); the aluminum busbar (110) is provided with a fixing hole (111) matching the heat rivet post (103);
the heat rivet post (103) is configured to insert into the fixing hole (111), wherein at least a portion of a circumferential sidewall of the heat rivet post (103) cooperates with at least a portion of an inner wall of the fixing hole (111), to fix the aluminum busbar (110) at a circumferential position of the heat rivet post (103).

16. The battery pack (1000) according to claim 15, wherein the busbar assembly (10) further comprises a second plastic bracket (10b), wherein the second plastic bracket (10b) is arranged opposite to the first plastic bracket (10a), and the cells (20) are arranged between the first plastic bracket (10a) and the second plastic bracket (10b);
one side of the first plastic bracket (10a) facing the second plastic bracket (10b) is provided with first fixing posts (105), and one side of the second plastic bracket (10b) facing the first plastic bracket (10a) is provided with second fixing posts (106) corresponding one-to-one with the first fixing posts (105);
wherein the first fixing post (105) and the second fixing post (106) are coaxially connected, and an axis of the first fixing post (105) and the second fixing post (106) is located in a gap among the cells (20).

17. The battery pack (1000) according to claim 15, wherein a top surface of the first plastic bracket (10a) is provided with a sinking groove (101); wherein the heat rivet post (103) is arranged at a bottom of the sinking groove (101), and the aluminum busbars (110) provided on the first plastic bracket (10a) are arranged in the sinking groove (101).

18. The battery pack (1000) according to claim 16, wherein a circumferential sidewall of each of the first fixing post (105) and the second fixing post (106) is provided with reinforcing ribs (1056).

19. The battery pack (1000) according to claim 16, wherein at least one of the plurality of the aluminum busbars (110) are arranged on the second plastic bracket (10b);
wherein the aluminum busbars (110) arranged on the second plastic bracket (10b) are configured to cooperate with the aluminum busbar (110) arranged on the first plastic bracket (10a) to connect the cells (20) in series.

20. The battery pack (1000) according to claim 19, wherein the second plastic bracket (10b) is provided with a plurality of heat rivet posts (103) corresponding one-to-one with the aluminum busbars (110) arranged on the second plastic bracket (10b) and for fixing the aluminum busbars (110) on the second plastic bracket (10b).
